(19) United States
(12) Patent Application Publication
(10) Pub. No.: US 2013/0003179 A1
(43) Pub. Date: Jan. 3, 2013

(54) COMPOSITE WITH NANO-STRUCTURED LAYER AND METHOD OF MAKING THE SAME

(75) Inventors: Kalc C. Vang, West Lakeland, MN (US); Olester Benson, JR., Woodbury, MN (US); Ta-Hua Yu, Woodbury, MN (US)

(73) Assignee: 3M INNOVATIVE PROPERTIES COMPANY, St. Paul, MN (US)

(21) Appl. No.: 13/581,598

(22) PCT Filed: Feb. 28, 2011
(86) PCT No.: PCT/US2011/026457

§ 371 Date: Aug. 28, 2012

Related U.S. Application Data
(60) Provisional application No. 61/310,157, filed on Mar. 3, 2010.

(51) Int. Cl. G02B 5/30; C23F 1/00; B82Y 20/00

(52) U.S. Cl. 359/485.01; 204/192.32; 977/773

(57) ABSTRACT

Nano-structured layers having a random nano-structured anisotropic major surface.

### CROSS REFERENCE TO RELATED APPLICATIONS

This application is a national stage filing under 35 U.S.C. 371 of PCT/US2011/026457, filed Feb. 28, 2011, which claims priority to U.S. Provisional Application No. 61/310,157, filed Mar. 3, 2010, the disclosure of which is incorporated by reference in its/their entirety herein.

### BACKGROUND

When light travels from one medium to another, some portion of the light is reflected from the interface between the two media. For example, typically about 4-5% of the light shining on a clear plastic substrate is reflected at the top surface.

Different approaches have been employed to reduce the reflection of polymeric materials. One approach is to use antireflective coatings such as multilayer reflective coatings consisting of transparent thin film structures with alternating layers of contrasting refractive index to reduce reflection. It is however difficult to achieve broadband antireflection using the multilayer antireflective coating technology.

Another approach involves using subwavelength surface structure (e.g., subwavelength scale surface gratings) for broadband antireflection. The methods for creating the subwavelength surface structure such as by lithography tend to be complicated and expensive. Additionally, it is challenging to obtain consistent low reflection broadband antireflection (i.e., average reflection over visible range less than less than 0.5 percent) from a roll-to-roll process with subwavelength scale surface gratings. On the other hand, high performance, relatively low reflection (i.e., average reflection over visible range less than less than 0.5 percent), relatively low birefringence (i.e., having an optical retardation value of less than 200 nm) antireflective articles are desired for optical film applications.

### Summary

Display devices, such as liquid crystal display (LCD) devices, are used in a variety of applications including computer monitors, televisions, hand-held devices, digital still cameras, and video cameras. LCD devices offer several advantages over traditional display devices that employ cathode ray tubes in that they often weigh less, are smaller, and use less power. An LCD panel is typically backlit by one or more linear or point light sources which are optically coupled to the panel such that images are generated. Optical films are commonly used in display devices. In the case of backlit display devices, a number of different optical films are often used in order to produce a display with high uniform brightness. For example, reflective polarizer films can be positioned between the light sources and the display panel in order to recycle and align the light propagating from the light sources such that they are in the same polarization to the front polarizer film to enhance the efficiency of light use thus providing what is sometimes referred to as optical gain. Enhancement of light transmission per pass during recycling of the backlit by reducing surface reflection of reflective polarizer films can therefore improve the use of light significantly effectively. There is therefore a need for the development of high performance nano-structured antireflective layers with reflective polarizer films for display applications.

In another aspect, the present disclosure the present disclosure provides a composite comprising:

a polarizer (e.g., an absorptive or reflective polarizer) having opposing first and second major surfaces; and

a nano-structured layer disposed on the first surface of the polarizer, the nano-structured layer comprising a matrix and a nano-scale dispersed phase, and having a random nano-structured anisotropic surface. In some embodiments, the nano-structured layer has a difference in refractive index in all direction of less than 0.05. In some embodiments, the nano-structured anisotropic surface has a percent reflection of less than 0.5% (or even less than 0.25%).

In another aspect, the present disclosure provides a method of making a composite of described herein, the method comprising:

providing a polarizer (e.g., an absorptive or a reflective polarizer) having opposing first and second major surfaces;

coating a coatable composition comprising a matrix material and a nano-scale dispersed phase in the matrix material on the first major surface of the polarizer and optionally drying the coating (and optionally curing the dried coating) to provide a layer comprising a matrix and a nano-scale dispersed phase in the matrix;

exposing a major surface of the layer to reactive ion etching, wherein the ion etching comprises:

placing the layer on a cylindrical electrode in a vacuum vessel; introducing etchant gas to the vacuum vessel at a predetermined pressure (e.g., in a range from 1 milliTorr to 20 milliTorr);

generating plasma (e.g., an oxygen plasma) between the cylindrical electrode and a counter-electrode;

rotating the cylindrical electrode to translate the polarizer; and

anisotropically etching the coating to provide the random nano-structured anisotropic surface.

In this application:

“difference in refractive index in all direction” of the nano-structured layer as used herein refers to the refractive index in all direction of the bulk nano-structured layer;

“nano-scale” means submicron (e.g., in a range about 1 nm and about 500 nm);

“nano-structured” means having one dimension on the nano-scale; and “anisotropic surface” means a surface having structural asperities having a height to width (i.e., average width) ratio of about 1.5:1 or greater (preferably, 2:1 or greater; more preferably, 5:1 or greater); and

“plasma” means a partially ionized gaseous or fluid state of matter containing electrons, ions, neutral molecules, and free radicals.

### BRIEF DESCRIPTION OF THE DRAWINGS

FIG. 1 is a first fragmentary perspective view of a coating apparatus useful in the present disclosure;

FIG. 2 is a second fragmentary perspective view of the apparatus of FIG. 1 taken from a different vantage point;

FIG. 3 is a fragmentary perspective view of another embodiment of the coating apparatus removed from its gas containing chamber;

FIG. 4 is a second perspective view of the apparatus of FIG. 3 taken from a different vantage point; and

FIG. 5 is a schematic cross-sectional view of a display using an exemplary antireflective layer described herein.

### DETAILED DESCRIPTION

Typically, nano-structured layers described herein comprise a microstructured surface having the nano-structured anisotropic surface thereon.

Typically, nano-structured layer described herein comprise a matrix (i.e., the continuous phase) and a nano-scale dispersed phase in the matrix. For the nano-scale dispersed phase, the size refers to less than about 100 nm for the smallest dimension of the nano-scale dispersed phase. The matrix can comprise, for example, polymeric material, liquid resins, inorganic material, or alloys or solid solutions (including miscible polymers). The matrix may comprise, for example, cross-linked material (e.g., cross-linked material was made by cross-linking at least one of cross-linkable materials multi(meth)acrylate, polyester, epoxy, fluoropolymer, urethane, or siloxane (which includes blends or copolymers thereof)) or thermoplastic material (e.g., at least one of the following polymers: polycarbonate, poly(meth)acrylate, polyester, nylon, siloxane, fluoropolymer, urethane, cyclic olefin copolymer, triacetate cellulose, or diacrylate cellulose (which includes blends or copolymers thereof)). Other matrix materials may include at least one of silicon oxide or tungsten carbide.

Useful polymeric materials include thermoplastics and thermosetting resins. Suitable thermoplastics include polyethylene terephthalate (PET), polystyrene, acrylonitrile butadiene styrene, polyvinyl chloride, polyvinylidene chloride, polycarbonate, polyacrylates, thermoplastic polyurethanes, polyvinyl acetate, polyamide, polyimide, polypropylene, polyester, polyethylene, poly(methylmethacrylate), polyethylene naphthalate, styrene acrylonitrile, silicone-polyoxamide polymers, triacetate cellulose, fluoropolymers, cyclic olefin copolymers, and thermoplastic elastomers.

Suitable thermosetting resins include allyl resin (including (meth)acrylates, polyester acrylates, urethane acrylates, epoxy acrylates and polyether acrylates), epoxies, thermosetting polyurethanes, and silicones or polysiloxanes. These resins can be formed from the reaction product of polymerizable compositions comprising the corresponding monomers and or oligomers.

In one embodiment, the polymerizable compositions includes at least one monomeric or oligomeric (meth)acrylate, preferably a urethane (meth)acrylate. Typically the monomeric or oligomeric (meth)acrylate is multi(meth)acrylate. The term “(meth)acrylate” is used to designate esters of acrylic and methacrylic acids, and “multi(meth)acrylate” designates a molecule containing more than one (meth)acrylate group, as opposed to “poly(meth)acrylate” which commonly designates (meth)acrylate polymers. Most often, the multi(meth)acrylate is a di(meth)acrylate, but it is also contemplated to employ tri(meth)acrylates, tetra(meth)acrylates and so on.

Suitable monomeric or oligomeric (meth)acrylates include alkyl (meth)acrylates such as methyl (meth)acrylate, ethyl (meth)acrylate, 1-propyl (meth)acrylate and t-butyl (meth)acrylate. The acrylates may include (fluoro)alkylester monomers of (meth)acrylic acid, the monomers being partially and or fully fluorinated (e.g., trifluoroethyl (meth)acrylate).

Examples of commercially available multi(meth)acrylate resins include those available, for example from Mitsubishi Rayon Co., Ltd., Tokyo, Japan, under the trade designation “DIABEAM”; from Nagase & Company, Ltd., New York, N.Y., under the trade designation “DINACOL”; from Shin-Nakamura Chemical Co., Ltd., Wakayama, Japan, under the trade designation “NK ESTER”; from Dainippon Ink & Chemicals, Inc, Tokyo, Japan, under the trade designation “UNIDIC; from Toagosei Co., Ltd., Tokyo, Japan, under the trade designation “ARONIX: from NOF Corp., White Plains, N.Y., under the trade designation “BLENMER”; from Nippon Kayaku Co., Ltd., Tokyo, Japan, under the trade designation “KAYARAD”, and from Kyoeisha Chemical Co., Ltd., Osaka, Japan, under the trade designations “LIGHT ESTER” and “LIGHT ACRYLATE”.

Oligomeric urethane multi(meth)acrylates are commercially available, for example, from Sartomer, Exton, Pa., under the trade designation “PHOTOMER 6000 Series” (e.g., “PHOTOMER 6010” and “PHOTOMER 6020”), and “CN 900 Series” (e.g., “CN966B85”, “CN964”, and “CN972”). Oligomeric urethane (meth)acrylates are also available, for example from Cytec Industries Inc., Woodland Park, N.J. 07424, under the trade designations “EBECRYL 8402”, “EBECRYL 8807” and “EBECRYL 4827”. Oligomeric urethane (meth)acrylates may also be prepared by the initial reaction of an alkylene or aromatic diisocyanate of the formula OCN—R₃—NCO with a polyol. Most often, the polyol is a diol of the formula HO—R₄—OH where R₃ is a C2-100 alkylene or an arylene group and R₄ is a C2-100 alkylene group. The intermediate product is then a urethane diol diisocyanate, which subsequently can undergo reaction with a hydroxyalkyl (meth)acrylate. Suitable diisocyanates include 2,2,4-trimethylhexylene diisocyanate and toluene diisocyanate. Alkylene diisocyanates are generally preferred. A particularly preferred compound of this type may be prepared from 2,2,4-trimethylhexylene diisocyanate, poly(caprolactone)diol and 2-hydroxyethyl methacrylate. In at least some cases, the urethane (meth)acrylate is preferably aliphatic.

The polymerizable compositions can be mixtures of various monomers and or oligomers, having the same or differing reactive functional groups. Polymerizable compositions comprising at least two different functional groups may be used, including (meth)acrylate, epoxy and urethane. The differing functionality may be contained in different monomeric and or oligomeric moieties or in the same monomeric and or oligomeric moiety. For example, a resin composition may comprise an acrylic or urethane resin having an epoxy group and or a hydroxyl group in the side chain, a compound having an amino group and, optionally, a silane compound having an epoxy group or amino group in the molecule.

The thermosetting resin compositions are polymerizable using conventional techniques such as thermal cure, photocure (cure by actinic radiation) and or e-beam cure. In one embodiment, the resin is photopolymerized by exposing it to ultraviolet (UV) and or visible light. Conventional curatives and or catalyst may be used in the polymerizable compositions and are selected based on the functional group(s) in the composition. Multiple curatives and or catalysts may be required if multiple cure functionality is being used. Combining one or more cure techniques, such as thermal cure, photocure and e-beam cure, is within the scope of the present disclosure.

Furthermore, the polymerizable resins can be compositions comprising at least one other monomer and or oligomer (i.e., other than those described above, namely the monomeric or oligomeric (meth)acrylate and the oligomeric urethane (meth)acrylate). This other monomer may reduce viscosity and/or improve thermomechanical properties and/or increase refractive index. Monomers having these properties include acrylic monomers (that is, acrylate and methacrylate esters, acrylamides and methacrylamides), styrene monomers and ethylenically unsaturated nitrogen heterocycles.

(meth)acrylate esters having other functionality are also useful. Compounds of this type are illustrated by the 2-(N-butylcarbamyl)ethyl (meth)acrylates, 2,4-dichlorophenyl acrylate, 2,4,6-tribromophenyl acrylate, tribromophenoxylethyl acrylate, t-butylphenyl acrylate, phenyl acrylate, phenyl thioacrylate, phenylthioethyl acrylate, alkoxylated phenyl acrylate, isobornyl acrylate and phenoxyethyl acrylate. The reaction product of tetrabromobisphenol A diepoxide and (meth)acrylic acid is also suitable.

The other monomer may also be a monomeric N-substituted or N,N-disubstituted (meth)acrylamide, especially an acrylamide. These include N-alkylacrylamides and N,N-dialkylacrylamides, especially those containing C1-4 alkyl groups. Examples are N-isopropylacrylamide, N-t-butylacrylamide, N,N-dimethylacrylamide and N,N-diethylacrylamide.

The other monomer may further be a polyol multi(meth)acrylate. Such compounds are typically prepared from aliphatic diols, triols, and/or tetraols containing 2-10 carbon atoms. Examples of suitable poly(meth)acrylates are ethylene glycol diacrylate, 1,6-hexanediol diacrylate, 2-ethyl-2-hydroxymethyl-1,3-propanediol triacylate (trimethylolpropane triacrylate), di(trimethylolpropane) tetraacrylate, pentaerythritol tetraacrylate, the corresponding methacrylates and the (meth)acrylates of alkoxylated (usually ethoxylated) derivatives of said polyols. Monomers having two or more (ethylenically unsaturated groups can serve as a crosslinker.

Styrenic compounds suitable for use as the other monomer include styrene, dichlorostyrene, 2,4,6-trichlorostyrene, 2,4,6-tribromostyrene, 4-methylstyrene and 4-phenoxystyrene. Ethylenically unsaturated nitrogen heterocycles include N-vinylpyrrolidone and vinylpyridine.

Constituent proportions in the radiation curable materials can vary. In general, the organic component can comprise about 30-100% monomeric and or oligomeric (meth)acrylate or oligomeric urethane multi(meth)acrylate, with any balance being the other monomer and or oligomer.

Surface leveling agents may be added to the matrix. The leveling agent is preferably used for smoothing the matrix resin. Examples include silicone-leveling agents, acrylic-leveling agents and fluorine-containing-leveling agents. In one embodiment, the silicone-leveling agent includes a polydimethyl siloxane backbone to which polyoxyalkylene groups are added.

Useful inorganic materials for the matrix include glasses, metals, metal oxides, and ceramics. Preferred inorganic materials include silicon oxide, zirconia, vanadium pentoxide, and tungsten carbide.

The nano-scale dispersed phase is a discontinuous phase randomly dispersed within the matrix. The nano-scale dispersed phase can comprise nanoparticles (e.g., nanospheres, nanocubes, and the like), nanotubes, nanofibers, caged molecules, hyperbranched molecules, micelles, or reverse micelles. Preferably, the dispersed phase comprises nanoparticles or caged molecules; more preferably, the dispersed phase comprises nanoparticles. The nano-scale dispersed phase can be associated or unassociated or both. The nano-scale dispersed phase can be well dispersed. Well dispersed means little agglomeration.

Nanoparticles have a mean diameter in the range from about 1 nm to about 100 nm. In some embodiments, the nanoparticles have average particle size of less than 100 nm (in some embodiments, in a range from 5 nm to 40 nm). The term “nanoparticle” can be further defined herein to mean colloidal (primary particles or associated particles) with a diameter less than about 100 nm. The term “associated particles” as used herein refers to a grouping of two or more primary particles that are aggregated and/or agglomerated. The term “aggregated” as used herein is descriptive of a strong association between primary particles which may be chemically bound to one another. The breakdown of aggregates into smaller particles is difficult to achieve. The term “agglomerated” as used herein is descriptive of a weak association of primary particles which may be held together by charge or polarity and can be broken down into smaller entities. The term “primary particle size” is defined herein as the size of a non-associated single particle. The dimension or size of the nano-scale dispersed phase can be determined by electronic microscopy (i.e., such as transmission electronic microscopy (TEM)).

Nanoparticles for the dispersed phase can comprise carbon, metals, metal oxides (e.g., SiO₂, ZrO₂, TiO₂, ZnO, magnesium silicate, indium tin oxide, and antimony tin oxide), carbides, nitrides, borides, halides, fluorocarbon solids (e.g., poly(tetrafluoroethylene)), carbonates (e.g., calcium carbonate), and mixtures thereof. In some embodiments, the nano-scale dispersed phase comprises at least one of SiO₂ nanoparticles, ZrO₂ nanoparticles, TiO₂ nanoparticles, ZnO nanoparticles, Al₂O₃ nanoparticles, calcium carbonate nanoparticles, magnesium silicate nanoparticles, indium tin oxide nanoparticles, antimony tin oxide nanoparticles, poly(tetrafluoroethylene) nanoparticles, or carbon nanoparticles. Metal oxide nanoparticles can be fully condensed. Metal oxide nanoparticles can be crystalline.

Typically, the nanoparticles/nanodispersed phase is present in the matrix in an amount in a range from about 1 percent by weight to about 60 percent by weight (preferably, in a range from about 10 percent by weight to about 40 percent by weight. Typically, on a volume basis, the nanoparticles/nanodispersed phase is present in the matrix in an amount in a range from about 0.5 percent by volume to about 40 percent by volume (preferably, in a range from about 5 percent by volume to about 25 percent by volume, more preferably, in a range from about 1 percent by volume to about 20 percent by volume, and even more preferably in a range from about 2 percent by volume to about 10 percent by volume) although amounts outside these ranges may also be useful.

Exemplary silicas are commercially available, for example, from Nalco Chemical Co., Naperville, Ill., under the trade designation “NALCO COLLOIDAL SILICA” such as products 1040, 1042, 1050, 1060, 2327 and 2329. Exemplary fumed silicas include those commercially available, for example, from Evonik Degusa Co., Parsippany, N.J. under the trade designation, “AEROSIL series OX-50”, as well as product numbers −130, −150, and −200; and from Cabot Corp., Tuscola, Ill., under the designations “CAB-O-SPERSE 2095”, “CAB-O-SPERSE A105”, and “CAB-O-SIL M5”. Other colloidal silica can be also obtained from Nissan Chemicals under the designations “IPA-ST”, “IPA-ST-L”, and “IPA-ST-ML”. Exemplary zirconias are available, for example, from Nalco Chemical Co. under the trade designation “NALCO OOSSOO8”.

Optionally, the nanoparticles are surface modified nanoparticles. Preferably, the surface-treatment stabilizes the nanoparticles so that the particles will be well dispersed in the polymerizable resin and result in a substantially homogeneous composition. Furthermore, the nanoparticles can be modified over at least a portion of its surface with a surface treatment agent so that the stabilized particles can copolymerize or react with the polymerizable resin during curing.

The nanoparticles are preferably treated with a surface treatment agent. In general, a surface treatment agent has a first end that will attach to the particle surface (covalently, ionically or through strong physisorption) and a second end that imparts compatibility of the particle with the resin and/or reacts with resin during curing. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes are preferred for silica and other for siliceous fillers. Silanes and carboxylic acids are preferred for metal oxides such as zirconia. The surface modification can be done either subsequent to mixing with the monomers or after mixing. It is preferred in the case of silanes to react the silanes with the particles or nanoparticle surface before incorporation into the resins. The required amount of surface modifier is dependant on several factors such as particle size, particle type, molecular weight of the modifier, and modifier type.

Representative embodiments of surface treatment agents include compounds such as isooctyl tri-methoxy-silane, N-(3-triethoxysilylpropyl)methoxyethoxy-ethoxyethyl carbamate (PEG3TES), N-(3-triethoxysilylpropyl)methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, vinyldimethylethoxysilane, pheyltrimethaoxysilane, n-octyltrimethoxysilane, dodecyltrimethoxysilane, octadecyltrimethoxysilane, propyltrimethoxysilane, hexyltrimethoxysilane, vinylmethyldiactoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-(2-(2-methoxyethoxy)ethoxy)acetic acid (MEEAA), beta-carboxyethylacrylate, 2-(2-methoxyethoxy)acetic acid, methoxyphenyl acetic acid, and mixtures thereof. A specific exemplary silane surface modifier, is commercially available, for example, from OSI Specialties, Crompton South Charleston, WV, under the trade designation “SILQUEST A1230”.

The surface modification of the particles in the colloidal dispersion can be accomplished in a variety of ways. The process involves the mixture of an inorganic dispersion with surface modifying agents. Optionally, a co-solvent can be added at this point, such as 1-methoxy-2-propanol, ethanol, isopropanol, ethylene glycol, N,N-dimethylacetamide and 1-methyl-2-pyrrolidinone. The co-solvent can enhance the solubility of the surface modifying agents as well as the surface modified particles. The mixture comprising the inorganic sol and surface modifying agents is subsequently reacted at room or an elevated temperature, with or without mixing. In one method, the mixture can be reacted at about 85° C. for about 24 hours, resulting in the surface modified sol. In another method, where metal oxides are surface modified the surface treatment of the metal oxide can preferably involve the adsorption of acidic molecules to the particle surface. The surface modification of the heavy metal oxide preferably takes place at room temperature.

The surface modification of ZrO₂ with silanes can be accomplished under acidic conditions or basic conditions. In one example, the silanes are heated under acid conditions for a suitable period of time. At which time the dispersion is combined with aqueous ammonia (or other base). This method allows removal of the acid counter ion from the ZrO₂ surface as well as reaction with the silane. In another method the particles are precipitated from the dispersion and separated from the liquid phase.

A combination of surface modifying agents can be useful, for example, wherein at least one of the agents has a functional group co-polymerizable with a hardenable resin. For example, the polymerizing group can be ethylenically unsaturated or a cyclic function subject to ring opening polymerization. An ethylenically unsaturated polymerizing group can be, for example, an acrylate or methacrylate, or vinyl group. A cyclic functional group subject to ring opening polymerization generally contains a heteroatom such as oxygen, sulfur or nitrogen, and preferably a 3-membered ring containing oxygen such as an epoxide.

Useful caged molecules for the nanodispersed phase include polyhedral oligomeric silsesquioxane molecules, which are cage-like hybrid molecules of silicone and oxygen. Polyhedral oligomeric silsesquioxane (POSS) molecules are derived from a continually evolving class of compounds closely related to silicones through both composition and a shared system of nomenclature. POSS molecules have two unique features (1) the chemical composition is a hybrid, intermediate (RSiO_{1.5}) between that of silica (SiO₂) and silicone (R₂SiO), and (2) the molecules are physically large with respect to polymer dimensions and nearly equivalent in size to most polymer segments and coils. Consequently, POSS molecules can be thought of as the smallest particles (about 1-1.5 nm) of silica possible. However unlike silica or modified clays, each POSS molecule contains covalently bonded reactive functionalities suitable for polymerization or grafting POSS monomers to polymer chains. In addition, POSS acrylate and methacrylate monomers are suitable for ultraviolet (UV) curing. High functionality POSS acrylates and methacrylates (e.g., available, for example, under the trade designations “MA0735” and “MA0736” from Hybrid Plastics, Inc., Hattiesburg, Miss.) are miscible with most of the UV-curable acrylic and urethane acrylic monomers or oligomers to form mechanically durable hardcoat in which POSS molecules form nano-phases uniformly dispersed in the organic coating matrix.

Carbon can also be used in the nanodispersed phase in the form of graphite, carbon nanotubes, bucky balls, or carbon black such as reported in U.S. Pat. No. 7,368,161 (McGurran et al.).

Additional materials that can be used in the nanodispersed phase include those available, for example, from Ciba Corporation, Tarrytown, N.Y. under the trade designation “IRGASTAT P18” and from Ampacet Corporation, Tarrytown, N.Y. under the trade designation “AMPACET LR-92967”.

The nano-structured anisotropic surface typically comprises nanofeatures having a height to width ratio of at least 2:1 (in some embodiments, at least 5:1, 10:1, 25:1, 50:1, 75:1, 100:1, 150:1, or even at least 200:1). Exemplary nanofeatures of the nano-structured anisotropic surface include nano-pillars or nano-columns, or continuous nano-walls comprising nano-pillars, nano-columns, anistropic nano-holes, or anisotropic nano-pores. Preferably, the nanofeatures have steep side walls that are roughly perpendicular to the polarizer. In some embodiments, the majority of the nano features are capped with dispersed phase material. In some embodiments, the concentration of the nanodispersed phase is higher at the surface than within the matrix. For example, the volume fraction of nanodispersed phase at surface can be 2 times or more higher than in the bulk

In some embodiments, the matrix may comprise materials for static dissipation in order to minimize attraction of dirt and particulate and thus maintain surface quality. Exemplary materials for static dissipation include those available, for example, polymers from Lubrizol, Wickliffe, Ohio, under the trade designation “STAT-RITE” such as X-5091, M-809, S-5530, S-400, S-403, and S-680; 3,4-polyethylenedioxythiophene-polystyrenesulfonate (PEDOT/PSS) from H. C. Starck, Cincinnati, Ohio; antistatic additives from Tomen America Inc., New York, N.Y., under the trade designations “PELESTAT NC6321” and “PELESTAT NC7530”); and antistatic compositions containing at least one ionic salt consisting of a nonpolymeric nitrogen onium cation and a weakly coordinating fluororganic anion as reported in U.S. Pat. No. 6,372,829 (Lamanna et al.) and in U.S. Patent Application Publication 2007/0141329 A1 (Yang et al.).

The nano-structured surface can be formed by anisotropically etching the matrix. The matrix comprising the nano-scale dispersed phase can be provided, for example, as a coating on a polarizer. The matrix comprising the dispersed phase can be coated on the polarizer and cured using methods known in the art (e.g., casting cure by casting drum, die coating, flow coating, or dip coating). The coating can be prepared in any desired thickness greater than about 1 micrometer (preferably greater than about 4 micrometers. In addition, the coating can be cured by UV, electron beam, or heat. Alternatively, the matrix comprising the dispersed phase may be the layer itself.

Suitable polarizers are known in the art, and include reflective and absorptive polarizers. A variety of polarizers films may be used as the substrate for the nano-structured layers described herein. The polarizer films may be multilayer optical films composed of some combination of all birefringent optical layers, some birefringent optical layers, or all isotropic optical layers. They can have ten or less layers, hundreds, or even thousands of layers. Exemplary multilayer polarizer films include those used in a wide variety of applications such as liquid crystal display devices to enhance brightness and/or reduce glare at the display panel. The polarizer film may also be a polarizer, including those used in sunglasses to reduce light intensity and glare. The polarizer film may comprise a polarizer film, a reflective polarizer film, an absorptive polarizer film, a diffuser film, a brightness enhancing film, a turning film, a mirror film, or a combination thereof. Exemplary reflective polarizer films include those reported in U.S. Pat. Nos. 5,825,543 (Ouderkirk et al.), 5,867,316 (Carlson et al.), 5,882,774 (Jonza et al.), 6,352,761 B1 (Hebrink et al.), 6,368,699 B1 (Gilbert et al.), and 6,927,900 B2 (Liu et al.); U.S. Pat. Appl. Pub. Nos. 2006/0084780 A1 (Hebrink et al.) and 2001/0013668 A1 (Neavin et al.); and PCT Pub. Nos. WO 95/17303 (Ouderkirk et al.), WO 95/17691 (Ouderkirk et al), WO95/17692 (Ouderkirk et al), WO 95/17699 (Ouderkirk et al.), WO 96/19347 (Jonza et al.), WO 97/01440 (Gilbert et al.), WO 99/36248 (Neavin et al.), and WO99/36262 (Hebrink et al.), the disclosures of which are incorporated herein by reference. Exemplary reflective polarizer films also include commercially available optical films marketed by 3M Company. St. Paul, Minn., under the trade designations “VIKUITI DUAL BRIGHTNESS ENHANCED FILM (DBEF)”, “VIKUITI BRIGHTNESS ENHANCED FILM (BEF)”, “VIKUITI DIFFUSE REFLECTIVE POLARIZER FILM (DRPF)”, “VIKUITI ENHANCED SPECULAR REFLECTOR (ESR)”, and “ADVANCED POLARIZER FILM (APF)”. Exemplary absorptive polarizer films are commercially available, for example, from Sanritz Corp., Tokyo, Japan, under the trade designation of “LLC2-5518SF”.

The optical film may have one or more non-optical layers (i.e., layers that do not significantly participate in the determination of the optical properties of the optical film). The non-optical layers may be used, for example, to impart or improve mechanical, chemical, optical, any number of additional properties as described in any of the above references; tear or puncture resistance, weatherability, and/or solvent resistance.

In some embodiments, the surface of the matrix comprising the nano-scale dispersed phase may be microstructured. For example, a polarizer (e.g., an absorptive or a reflective polarizer), with a v-groove microstructured surface can be coated with polymerizable matrix materials, optionally comprising a nanodispersed phase and treated by plasma etching to form nanostructures on v-groove microstructured surface. Other examples include a fine micro-structured surface resulting from controlling the solvent evaporation process from multi-solvent coating solutions, reported as in U.S. Pat. No. 7,378,136 (Pokorny et al.); or the structured surface from the micro-replication method reported in U.S. Pat. No. 7,604,381 (Hebrink et al.); or any other structured surface induced, for example, by electrical and magnetic field.

The matrix can be anisotropically etched using chemically reactive plasma. The RIE process, for example, involves generating plasma under vacuum by an electromagnetic field. High energy ions from the plasma attack or etch away the matrix material.

A typical RIE system consists of a vacuum chamber with two parallel electrodes, the “powered electrode” (or “sample carrier electrode”) and the counter-electrode, which create an electric field that accelerates ions toward. The powered electrode is situated in the bottom portion of the chamber and is electrically isolated from the rest of the chamber. The layer or sample to be nano-structured is placed on the powered electrode. Reactive gas species can be added to the chamber, for example, through small inlets in the top of the chamber and can exit to the vacuum pump system at the bottom of the chamber. Plasma is formed in the system by applying a RF electromagnetic field to the powered electrode. The field is typically produced using a 13.56 MHz oscillator, although other RF sources and frequency ranges may be used. The gas molecules are broken and can become ionized in the plasma and accelerated toward the powered electrode to etch the sample. The large voltage difference causes the ions to be directed toward the powered electrode where they collide with the sample to be etched. Due to the mostly vertical delivery of the ions, the etch profile of the sample is substantially anisotropic. Preferably, the powered electrode is smaller than the counter-electrode creating a large voltage potential across the ion sheath adjacent the powered electrode. Preferably, the etching is to a depth greater than about 100 nm.

The process pressure is typically maintained at below about 20 mTorr (preferably, below about 10 mTorr) but greater than about 1 mTorr. This pressure range is very conducive for generation of the anisotropic nanostructure in a cost effective manner. When the pressure is above about 20 mTorr, the etching process becomes more isotropic because of the collisional quenching of the ion energy. Similarly, when the pressure goes below about 1 mTorr, the etching rate becomes very low because of the decrease in number density of the reactive species. Also, the gas pumping requirements become very high.

The power density of the RF power of the etching process is preferably in the range of about 0.1 watts/cm³ to about 1.0 watts/cm³ (preferably, about 0.2 watts/cm³ to about 0.3 watts/cm³).

The type and amount of gas utilized will depend upon the matrix material to be etched. The reactive gas species need to selectively etch the matrix material rather than the dispersed phase. Additional gases may be used for enhancing the etching rate of hydrocarbons or for the etching of non-hydrocarbon materials. For example, fluorine containing gases such as perfluoromethane, perfluoroethane, perfluoropropane, sulfurhexafluoride, and nitrogen trifluoride can be added to oxygen or introduced by themselves to etch materials such as SiO₂, tungsten carbide, silicon nitride, and amorphous silicon. Chlorine-containing gases can likewise be added for the etching of materials such as aluminum, sulfur, boron carbide, and semiconductors from the Group II-VI (including cadmium, magnesium, zinc, sulfur, selenium, tellurium, and combinations thereof and from the Group III-V (including, but not limited to, aluminum, gallium, indium, arsenic, phosphorous, nitrogen, antimony, or combinations thereof. Hydrocarbon gases such as methane can be used for the etching of materials such as gallium arsenide, and gallium, indium. Inert gases, particularly heavy gases such as argon can be added to enhance the anisotropic etching process.

The method of the invention can also be carried out using a continuous roll-to-roll process. For example, the method of the invention can be carried out using “cylindrical” RIE. Cylindrical RIE utilizes a rotating cylindrical electrode to provide anisotropically etched nanostructures on the surface of the layers of the invention.

In general, cylindrical RIE for making the nano-structured layers of the invention can be described as follows. A rotatable cylindrical electrode (“drum electrode”) powered by radio-frequency (RF) and a grounded counter-electrode are provided inside a vacuum vessel. The counter-electrode can comprise the vacuum vessel itself. Gas comprising an etchant is fed into the vacuum vessel, and plasma is ignited and sustained between the drum electrode and the grounded counter-electrode. The conditions are selected so that sufficient ion bombardment is directed perpendicular to the circumference of the drum. A continuous layer comprising the matrix containing the nanodispersed phase can then be wrapped around the circumference of the drum and the matrix can be etched in the direction normal to the plane of the layer. The matrix can be in the form of a coating on a layer such as on a film or web, or the matrix can be the layer itself. The exposure time of the layer can be controlled to obtain a predetermined etch depth of the resulting nanostructure. The process can be carried out at an operating pressure of approximately 10 mTorr.

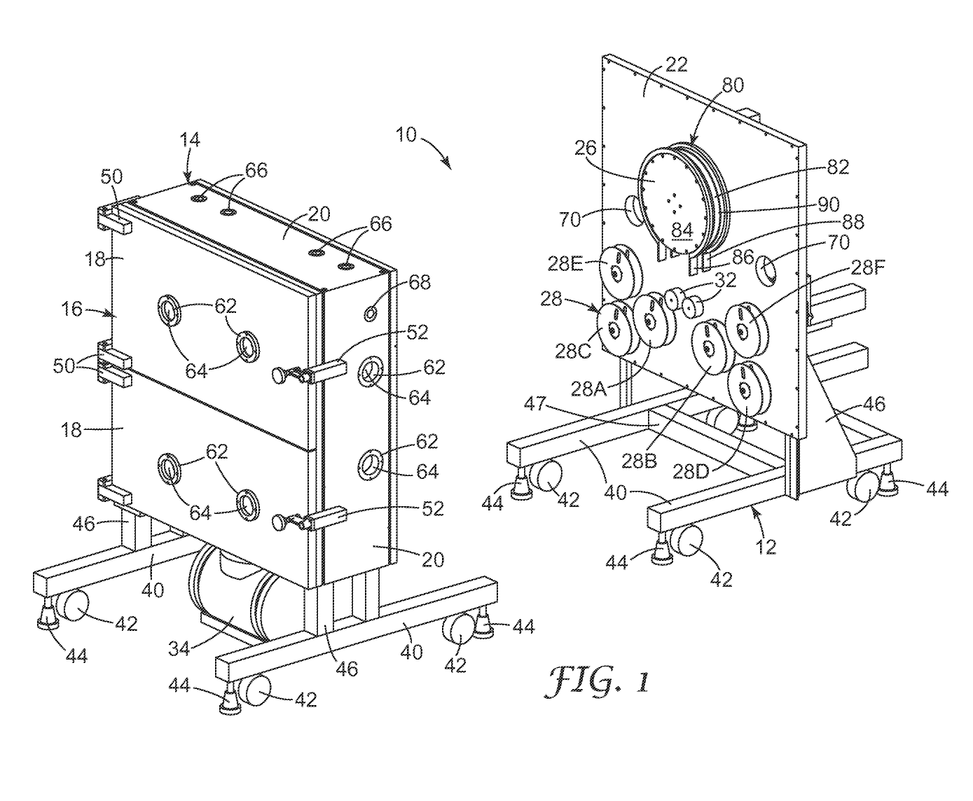

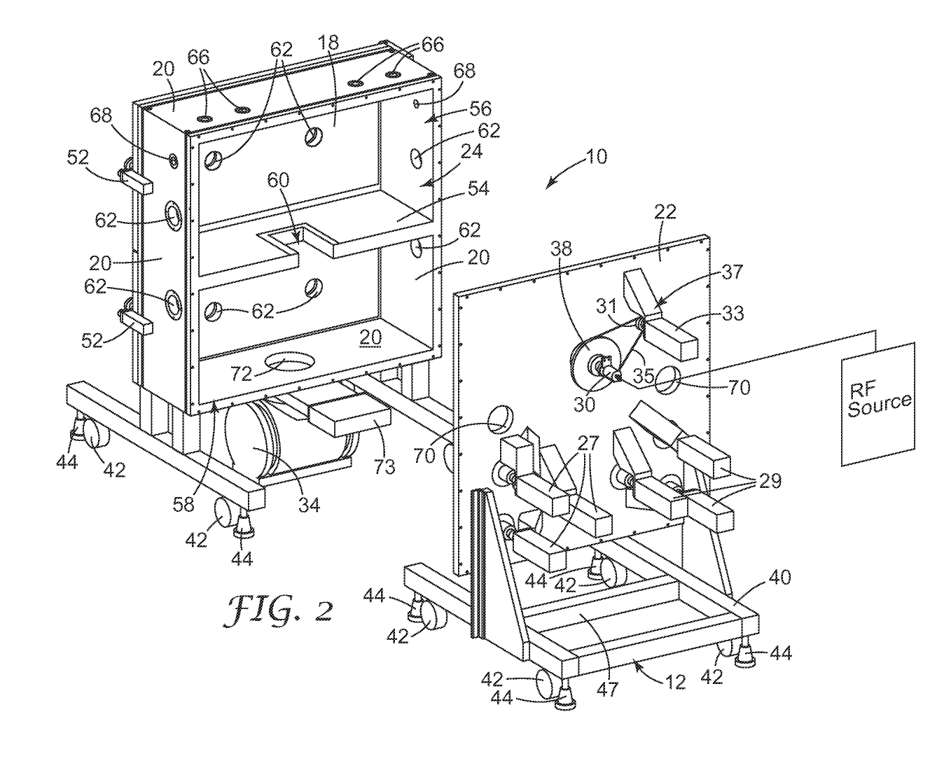

FIGS. 1 and 2 illustrate a cylindrical RIE apparatus that is useful for the methods of the invention. A common element for plasma creation and ion acceleration is generally indicated as 10. This RIE apparatus 10 includes a support structure 12, a housing 14 including a front panel 16 of one or more doors 18, side walls 20 and a back plate 22 defining an inner chamber 24 therein divided into one or more compartments, a drum 26 rotatably affixed within the chamber, a plurality of reel mechanisms rotatably affixed within the chamber and referred to generally as 28, drive assembly 37 for rotatably driving drum 26, idler rollers 32 rotatably affixed within the chamber, and vacuum pump 34 fluidly connected to the chamber.

Support structure 12 is any means known in the art for supporting housing 14 in a desired configuration, a vertically upright manner in the present case. As shown in FIGS. 1 and 2, housing 14 can be a two-part housing as described below in more detail. In this embodiment, support structure 12 includes cross supports 40 attached to each side of the two-part housing for supporting apparatus 10. Specifically, cross supports 40 include both wheels 42 and adjustable feet 44 for moving and supporting, respectively, apparatus 10. In the embodiment shown in FIGS. 1 and 2, cross supports 40 are attached to each side of housing 14 through attachment supports 46. Specifically, cross supports 40 are connected to one of side wails 20, namely the bottom side wall, via attachment supports 46, while cross supports 40 on the other side of housing 14 are connected to back plate 22 by attachment supports 46. An additional crossbar 47 is supplied between cross supports 40 on the right-hand side of apparatus 10 as shown in FIG. 1. This can provide additional structural reinforcement.

Housing 14 can be any means of providing a controlled environment that is capable of evacuation, containment of gas introduced after evacuation, plasma creation from the gas, ion acceleration, and etching. In the embodiment shown in FIGS. 1 and 2, housing 14 has outer walls that include front panel 16, four side walls 20, and a back plate 22. The outer walls define a box with a hollow interior, denoted as chamber 24. Side walls 20 and back plate 22 are fastened together, in any manner known in the art, to rigidly secure side walls 20 and back plate 22 to one another in a manner sufficient to allow for evacuation of chamber 24, containment of a fluid for plasma creation, plasma creation, ion acceleration, and etching. Front panel 16 is not fixedly secured so as to provide access to chamber 24 to load and unload the substrate and to perform maintenance. Front panel 16 is divided into two plates connected via hinges 50 (or an equivalent connection means) to one of side walls 20 to define a pair of doors 18. These doors seal to the edge of side walls 20, preferably through the use of a vacuum seal (for example, an O-ring). Locking mechanisms 52 selectively secure doors 18 to side walls 20 and can be any mechanism capable of securing doors 18 to walls 20 in a manner allowing for evacuation of chamber 24, storage of a fluid for plasma creation, plasma creation, ion acceleration, and etching.

In one embodiment, chamber 24 is divided by a divider wall 54 into two compartments 56 and 58. A passage or hole 60 in wall 54 provides for passage of fluids or substrate between compartments. Alternatively, the chamber can be only one compartment or three or more compartments. Preferably, the chamber is only one compartment.

Housing 14 includes a plurality of view ports 62 with high pressure, clear polymeric plates 64 sealably covering ports 62 to allow for viewing of the etching process occurring therein. Housing 14 also includes a plurality of sensor ports 66 in which various sensors (e.g., temperature, pressure, etc.) can be secured. Housing 14 further includes inlet ports 68 providing for conduit connection through which fluid can be introduced into chamber 24 as needed. Housing 14 also includes pump ports 70 and 72 that allow gases and liquids to be pumped or otherwise evacuated from chamber 24.

Pump 34 is shown suspended from one of sides 20, preferably the bottom (as shown in FIG. 2). Pump 34 can be, for example, a turbo-molecular pump fluidly connected to the controlled environment within housing 14. Other pumps, such as diffusion pumps or cryopumps, can be used to evacuate lower compartment 58 and to maintain operating pressure therein. The process pressure during the etching step is preferably chosen to be in a range from about 1 mTorr to about 20 mTorr to provide anisotropic etching. Sliding valve 73 is positioned along this fluid connection and can selectively intersect or block fluid communication between pump 34 and the interior of housing 14. Sliding valve 73 is movable over pump port 62 so that pump port 62 can be fully open, partially open, or closed with respect to fluid communication with pump 34.

Drum 26 preferably is a cylindrical electrode 80 with an annular surface 82 and two planar end surfaces 84. The electrode can be made of any electrically conductive material and preferably is a metal (e.g., aluminum, copper, steel, stainless steel, silver, chromium or an alloy thereof). Preferably, the electrode is aluminum, because of the ease of fabrication, low sputter yield, and low costs.

Drum 26 is further constructed to include non-coated, conductive regions that allow an electric field to permeate outward as well as non-conductive, insulative regions for preventing electric field permeation and thus for limiting film coating to the non-insulated or conductive portions of the electrode. The electrically non-conductive material typically is an insulator, such as a polymer (e.g., polytetrafluoroethylene). Various embodiments that fulfill this electrically non-conductive purpose so as to provide only a small channel, typically the width of the polarizer to be coated, as a conductive area can be envisioned by one of ordinary skill in the art.

FIG. 1 shows an embodiment of drum 26 where annular surface 82 and end surfaces 84 of drum 26 are coated with an electrically non-conductive or insulative material, except for annular channel 90 in annular surface 82 which remains uncoated and thus electrically conductive. In addition, a pair of dark space shields 86 and 88 cover the insulative material on annular surface 82, and in some embodiments cover end surfaces 84. The insulative material limits the surface area of the electrode along which plasma creation and negative biasing may occur. However, since the insulative materials sometimes can become fouled by the ion bombardment, dark space shields 86 and 88 can cover part or all of the insulated material. These dark space shields may be made from a metal such as aluminum but do not act as conductive agents because they are separated from the electrode by means of an insulating material (not shown). This allows confinement of the plasma to the electrode area.

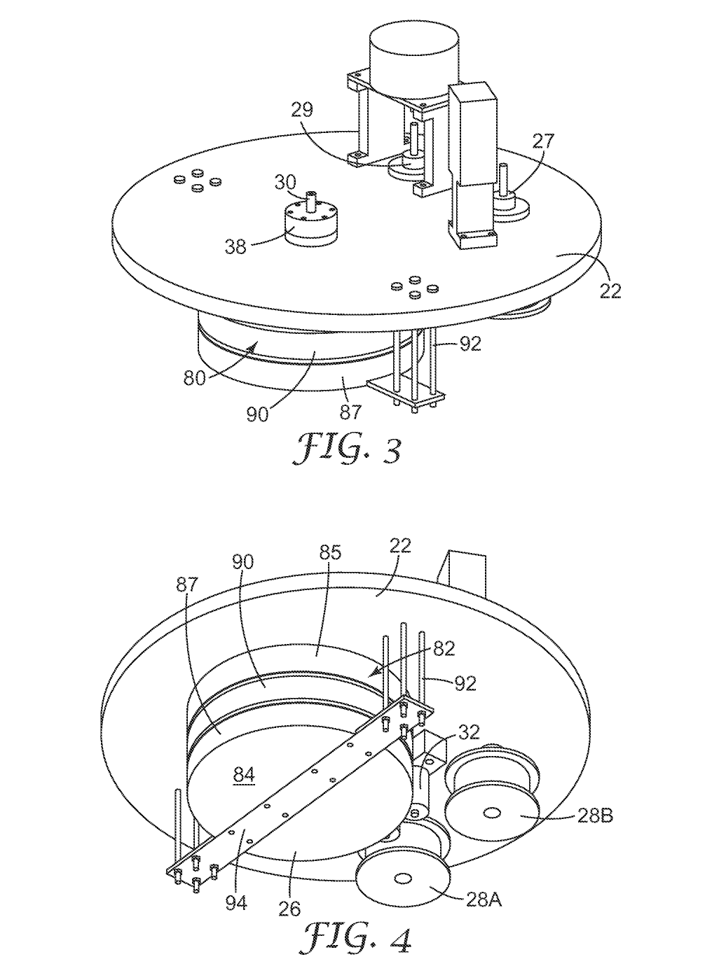

Another embodiment of drum 26 is shown in FIGS. 3 and 4 where drum 26 includes a pair of insulative rings 85 and 87 affixed to annular surface 82 of drum 26. In some embodiments, insulative ring 87 is a cap which acts to also cover end surface 84. Bolts 92 secure support means 94, embodied as a flat plate or strap, to back plate 22. Bolts 92 and support 94 can assist in supporting the various parts of drum 26. The pair of insulative rings 85 and 87, once affixed to annular surface 82, define an exposed electrode portion embodied as channel 90.

Electrode 80 is covered in some manner by an insulative material in all areas except where the polarizer, as applicable, contacts the electrode (i.e., touching or within the plasma dark space limit of the electrode (e.g., about 3 mm)). This defines an exposed electrode portion that can be in intimate contact with the polarizer. The remainder of the electrode is covered by an insulative material. When the electrode is powered and the electrode becomes negatively biased with respect to the resultant plasma, this relatively thick insulative material prevents etching on the surfaces it covers. As a result, etching is limited to the uncovered area (i.e., that which is not covered with insulative material, channel 90), which preferably is covered by relatively thin polarizer.

Referring to FIGS. 1 and 2, drum 26 is rotatably affixed to back plate 22 through a ferrofluidic feedthrough and rotary union 38 (or an equivalent mechanism) affixed within a hole in back plate 22. The ferrofluidic feedthrough and rotary union provide separate fluid and electrical connection from a standard coolant fluid conduit and electrical wire to hollow coolant passages and the conductive electrode, respectively, of rotatable drum 26 during rotation while retaining a vacuum seal. The rotary union also supplies the necessary force to rotate the drum, which force is supplied from any drive means such as a brushless DC servo motor. However, connection of drum 26 to back plate 22 and the conduit and wire may be performed by any means capable of supplying such a connection and is not limited to a ferrofluidic feedthrough and a rotary union. One example of such a ferrofluidic feedthrough and rotary union is a two-inch (about 5 cm) inner diameter hollow shaft feedthrough made by Ferrofluidics Co., Nashua, N.H.

Drum 26 is rotatably driven by drive assembly 37, which can be any mechanical and/or electrical system capable of translating rotational motion to drum 26. In the embodiment shown in FIG. 2, drive assembly 37 includes motor 33 with a drive shaft terminating in drive pulley 31 that is mechanically connected to a driven pulley 39 rigidly connected to drum 26. Belt 35 (or equivalent structure) translates rotational motion from drive pulley 31 to driven pulley 39.

The plurality of reel mechanisms 28 are rotatably affixed to back plate 22. The plurality of reel mechanisms 28 includes a substrate reel mechanism with a pair of substrate spools 28A and 28B, and, in some embodiments, also can include a spacing web reel mechanism with a pair of spacing web spools 28C and 28D, and masking web reel mechanism with a pair of masking web spools 28E and 28F, where each pair includes one delivery and one take-up spool. As is apparent from FIG. 2, at least each take-up reel 28B, 28D, and 28F includes a drive mechanism 27 mechanically connected thereto such as a standard motor as described below for supplying a rotational force that selectively rotates the reel as needed during etching. In addition, each delivery reel 28A, 28C, and 28E in select embodiments includes a tensioner for supplying tautness to the webs and/or a drive mechanism 29.

Each reel mechanism includes a delivery and a take-up spool which may be in the same or a different compartment from each other, which in turn may or may not be the same compartment the electrode is in. Each spool is of a standard construction with an axial rod and a rim radially extending from each end defining a groove in which an elongated member, in this case a substrate or web, is wrapped or wound. Each spool is securably affixed to a rotatable stem sealably extending through back plate 22. In the case of spools to be driven, the stem is mechanically connected to a motor 27 (e.g., a brushless DC servo motor). In the case of non-driven spools, the spool is merely coupled in a rotatable manner through a drive mechanism 29 to back plate 22 and may include a tension mechanism to prevent slack.

RIE apparatus 10 also includes idler rollers 32 rotatably affixed within the chamber and pump 34 fluidly connected to the chamber. The idler rollers guide the substrate from the substrate spool 28A to channel 90 on drum 26 and from channel 90 to take-up substrate spool 28B. In addition, where spacing webs and masking webs are used, idler rollers 32 guide these webs and the substrate from substrate spool 28A and masking web spool 28E to channel 90 and from channel 90 to take-up substrate spool 28B and take-up masking web spool 28F, respectively.

RIE apparatus 10 further includes a temperature control system for supplying temperature controlling fluid to electrode 80 via ferrofluidic feedthrough 38. The temperature control system may be provided on apparatus 10 or alternatively may be provided from a separate system and pumped to apparatus 10 via conduits so long as the temperature control fluid is in fluid connection with passages within electrode 80. The temperature control system may heat or cool electrode 80 as is needed to supply an electrode of the proper temperature for etching. In a preferred embodiment, the temperature control system is a coolant system using a coolant (e.g., water, ethylene glycol, chloro fluorocarbons, hydrofluoroethers, and liquefied gases (e.g., liquid nitrogen)).

RIE apparatus 10 also includes an evacuation pump fluidly connected to evacuation port(s) 70. This pump may be any vacuum pump, such as a Roots blower, a turbo molecular pump, a diffusion pump, or a cryopump, capable of evacuating the chamber. In addition, this pump may be assisted or backed up by a mechanical pump. The evacuation pump may be provided on apparatus 10 or alternatively may be provided as a separate system and fluidly connected to the chamber.

RIE apparatus 10 also includes a fluid feeder, preferably in the form of a mass flow controller that regulates the fluid used to create the thin film, the fluid being pumped into the chamber after evacuation thereof. The feeder may be provided on apparatus 10 or alternatively may be provided as a separate system and fluidly connected to the chamber. The feeder supplies fluid in the proper volumetric rate or mass flow rate to the chamber during etching. The etching gases can include oxygen, argon, chlorine, fluorine, carbon tetrafluoride, carbontetrachloride, perfluoromethane, perfluoroethane, perfluoropropane, nitrogen trifluoride, sulfur hexafluoride, and methane. Mixtures of gases may be used advantageously to enhance the etching process.

RIE apparatus 10 also includes a power source electrically connected to electrode 80 via electrical terminal 30. The power source may be provided on apparatus 10 or alternatively may be provided on a separate system and electrically connected to the electrode via electrical terminal (as shown in FIG. 2). In any case, the power source is any power generation or transmission system capable of supplying sufficient power. (See discussion infra.)

Although a variety of power sources are possible, RF power is preferred. This is because the frequency is high enough to form a self bias on an appropriately configured powered electrode but not high enough to create standing waves in the resulting plasma. RF power is scalable for high output (wide webs or substrates, rapid web speed). When RF power is used, the negative bias on the electrode is a negative self bias, that is, no separate power source need be used to induce the negative bias on the electrode. Because RF power is preferred, the remainder of this discussion will focus exclusively thereon.

The RF power source powers electrode 80 with a frequency in the range of 0.01 MHz to 50 MHz preferably 13.56 MHz or any whole number (e.g., 1, 2, or 3) multiple thereof. This RF power as supplied to electrode 80 creates a plasma from the gas within the chamber. The RF power source can be an RF generator such as a 13.56 MHz oscillator connected to the electrode via a network that acts to match the impedance of the power supply with that of the transmission line (which is usually 50 ohms resistive) so as to effectively transmit RF power through a coaxial transmission line.

Upon application of RF power to the electrode, the plasma is established. In a 15 RF plasma the powered electrode becomes negatively biased relative to the plasma. This bias is generally in the range of 500 volts to 1400 volts. This biasing causes ions within the plasma to accelerate toward electrode 80. Accelerating ions etch the layer in contact with electrode 80 as is described in more detail below.

In operation, a full spool of substrate upon which etching is desired is inserted over the stem as spool 28A. Access to these spools is provided through lower door 18 since, in FIGS. 1 and 2, the spools are located in lower compartment 58 while etching occurs in upper compartment 56. In addition, an empty spool is fastened opposite the substrate holding spool as spool 28B so as to function as the take-up spool after etching has occurred.

If a spacer web is desired to cushion the substrate during winding or unwinding, spacer web delivery and/or take-up spool can be provided as spools 28C and 28D (although the location of the spools in the particular locations shown in the figures is not critical). Similarly, if etching is desired in a pattern or otherwise partial manner, a masking web can be positioned on an input spool as spool 28E and an empty spool is positioned as a take-up spool as spool 28F.

After all of the spools with and without substrates or webs are positioned, the substrate on which etching is to occur (and any masking web to travel therewith around the electrode) are woven or otherwise pulled through the system to the take-up reels. Spacer webs generally are not woven through the system and instead separate from the substrate just before this step and/or are provided just after this step. The substrate is specifically wrapped around electrode 80 in channel 90 thereby covering the exposed electrode portion. The substrate is sufficiently taut to remain in contact with the electrode and to move with the electrode as the electrode rotates so a length of substrate is always in contact with the electrode for etching. This allows the substrate to be etched in a continuous process from one end of a roll to the other. The substrate is in position for etching and lower door 18 is sealed closed.

Chamber 24 is evacuated to remove all air and other impurities. Once an etchant gas mixture is pumped into the evacuated chamber, the apparatus is ready to begin the process of etching. The RF power source is activated to provide an RF electric field to electrode 80. This RF electric field causes the gas to become ionized, resulting in the formation of a plasma with ions therein. This is specifically produced using a 13.56 MHz oscillator, although other RF sources and frequency ranges may be used.

Once the plasma has been created, a negative DC bias voltage is created on electrode 80 by continuing to power the electrode with RF power. This bias causes ions to accelerate toward channel (non-insulated electrode portion 90 of electrode) 80 (the remainder of the electrode is either insulated or shielded). The ions selectively etch the matrix material (versus the dispersed phase) in the length of substrate in contact with channel 90 of electrode 80 causing anisotropic etching of the matrix material of on that length of substrate.

For continuous etching, the take-up spools are driven so as to pull the substrate and any masking webs through the upper compartment 56 and over electrode 80 so that etching of the matrix occurs on any unmasked substrate portions in contact with annular channel 90. The substrate is thus pulled through the upper compartment continuously while a continuous RF field is placed on the electrode and sufficient reactive gas is present within the chamber. The result is a continuous etching on an elongated substrate, and substantially only on the substrate. Etching does not occur on the insulated portions of the electrode nor does etching occur elsewhere in the chamber. To prevent the active power fed to the plasma from being dissipated in the end plates of the cylindrical electrode, grounded dark space shields 86 and 88 can be used. Dark space shields 86 and 88 can be of any shape, size, and material that is conducive to the reduction of potential fouling. In the embodiment shown in FIGS. 1 and 2, dark space shields 86 and 88 are metal rings that fit over drum 26 and the insulation thereon. Dark space shields 86 and 88 do not bias due to the insulative material that covers drum 26 in the areas where dark space shields 86 and 88 contact drum 26. The dark space shields in this ring-like embodiment further include tabs on each end thereof extending away from drum 26 in a non-annular manner. These tabs can assist in aligning the substrate within channel 90.

Preferably, the temperature control system pumps fluid through electrode 80 throughout the process to keep the electrode at a desired temperature. Typically, this involves cooling the electrode with a coolant as described above, although heating in some cases may be desirable. In addition, since the substrate is in direct contact with the electrode, heat transfer from the plasma to the substrate is managed through this cooling system, thereby allowing the coating of temperature sensitive films such as polyethyleneterephthalate, and polyethylene naphthalate.

After completion of the etching process, the spools can be removed from shafts supporting them on the wall. The substrate with the nano-structured layer thereon is on spool 28B and is ready for use.

In some embodiments, nano-structured layers described herein, the nano-structured layer comprise additional layers. For example, the layer may comprise an additional fluorochemical layer to give the layer improved water and/or oil repellency properties. The nano-structured surface may also be post treated (e.g., with an additional plasma treatment). Plasma post treatments may include surface modification to change the chemical functional groups that might be present on the nanostructure or for the deposition of thin films that enhance the performance of the nanostructure. Surface modification can include the attachment of methyl, fluoride, hydroxyl, carbonyl, carboxyl, silanol, amine, or other functional groups. The deposited thin films can include fluorocarbons, glass-like, diamond-like, oxide, carbide, nitride, or other materials. When the surface modification treatment is applied, the density of the surface functional groups is high due to the large surface area of the anisotropically etched nano-structured surface. When amine functionality is used, biological agents such as antibodies, proteins, and enzymes can be easily grafted to the amine functional groups. When silanol functionality is used, silane chemistries can be easily applied to the nano-structured surface due to the high density of silanol groups. Antimicrobial, easy-clean, and anti-fouling surface treatments that are based on silane chemistry are commercially available. Antimicrobial treatments may include quaternary ammonium compounds with silane end group. Easy-clean compounds may include fluorocarbon treatments such as perfluoropolyether silane, and hexafluoropropyleneoxide (HFPO) silane. Anti-fouling treatments may include polyethyleneglycol silane. When thin films are used, these thin films may provide additional durability to the nanostructure or provide unique optical effects depending upon the refractive index of the thin film. Specific types of thin films may include diamond-like carbon (DLC), diamond-like glass (DLG), amorphous silicon, silicon nitride, plasma polymerized silicone oil, aluminum, and copper.

Nano-structured layers described herein can exhibit one or more desirable properties such as antireflective properties, light absorbing properties, antifogging properties, improved adhesion and durability.

For example, in some embodiments, the surface reflectivity of the nano-structured anisotropic surface is about 50% or less than the surface reflectivity of an untreated surface. As used herein with respect to comparison of surface properties, the term “untreated surface” means the surface of an layer comprising the same matrix material and the same nanodispersed phase (as the nano-structured surface of the invention to which it is being compared) but without a nano-structured anisotropic surface.

Some embodiments further comprise a layer or coating comprising, for example, ink, encapsulant, adhesive, or metal attached to the nano-structured anisotropic surface. The layer or coating can have improved adhesion to the nano-structured anisotropic surface of the invention than to an untreated surface.

Composites described herein are useful for numerous applications including, for example, display applications (e.g., liquid crystal displays (LCD), light emitting diode (LED) displays, or plasma displays); light extraction; electromagnetic interference (EMI) shielding, ophthalmic lenses; face shielding lenses or films; window films; antireflection for construction applications; and, construction applications or traffic signs. Nano-structured layers described herein are also useful for solar applications such as solar films. They can be used as the front surface of solar thermal hot liquid/air heat panels or any solar energy absorbing device; for solar thermal absorbing surfaces having micro- or macro-columns with additional nano-scale surface structure; for the front surface of flexible solar photovoltaic cells made with amorphous silica photovoltaic cells or CIGS photovoltaic cells; and for the front surface of a film applied on top of flexible photovoltaic cells. Composites layers described herein are also useful for mobile hand-held devices and liquid crystal display television displays applications. The composites layers described herein are also useful for solar, window, face shielding, and eyewear applications.

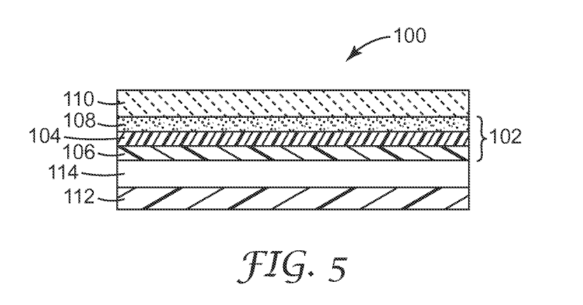

FIG. 5 shows a schematic cross sectional view of an exemplary display 100, such as a LCD, using an antireflective layer as disclosed herein. In one embodiment, a composite 102 includes a polarizer 104 having opposing first and second surfaces with an antireflective layer 106 disposed on the first surface of the substrate and an optically clear adhesive 108 disposed on the second surface of the substrate. Optionally a release liner (not shown) can be used to protect the optically clear adhesive and a premask (also not shown) can be used to protect the antireflective coating during processing and storage. The composite 102 is then laminated to a glass, brightness enhancement film, diffuser, polarizer or another polarizer 110 such that the optically clear adhesive is in direct contact with the glass brightness enhancement film, diffuser, polarizer or another polarizer which is then assembled to a liquid crystal module 112, typically, with an air gap 114 disposed between the antireflective coating and the liquid crystal module.

The optically clear adhesives that may be used in the present disclosure are preferably those that exhibit an optical transmission of at least about 90%, or even higher, and a haze value of below about 5% or even lower, as measured on a 25 micrometer thick sample in the matter described below in the Example section under the Haze and Transmission Testing for optically clear adhesive. Suitable optically clear adhesives may have antistatic properties, may be compatible with corrosion sensitive layers, and may be able to be released from the polarizer by stretching the adhesive. Illustrative optically clear adhesives include those described in PCT Pub. No. WO 2008/128073 (Everaerts et al.) relating to antistatic optically clear pressure sensitive adhesive; U.S. Patent Application Publications US 2009/0229732 A1 (Determan et al.) relating to stretch releasing optically clear adhesive; U.S. Pat. Application Publication No. US 2009/0087629 (Everaerts et al.) relating to indium tin oxide compatible OCA; U.S. Patent Applications having Ser. No. 12/181,667 (Everaerts et al.) relating to antistatic optical constructions having optically transmissive adhesive; U.S. Patent Applications having Ser. No. 12/538,948 (Everaerts et al.) relating to adhesives compatible with corrosion sensitive layers; U.S. Provisional Patent Application No. 61/036,501 (Hamerski et al.) relating to optically clear stretch release adhesive tape; and U.S. Provisional Patent Application No. 61/141,767 (Hamerski et al.) stretch release adhesive tape. In one embodiment, the optically clear adhesive has a thickness of about 5 micrometer or less.

In some embodiments, nano-structured layers described herein further comprise a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane(which includes blends or copolymers thereof). Commercially available liquid-resin based materials (typically referred to as “hardcoats”) may be used as the matrix or as a component of the matrix. Such materials include that available from California Hardcoating Co., San Diego, Calif., under the trade designation “PERMANEW”; and from Momentive Performance Materials, Albany, N.Y. under the trade designation “UVHC”. Additionally, commercially available nanoparticle filled matrix may be used, such as those available from Nanoresins AG, Geesthacht Germany, under the trade designations “NANOCRYL” and “NANOPDX”.

Additionally, nanoparticulate containing hardcoat films, such as those available from Toray Advanced Films Co., Ltd., Tokyo, Japan, under the trade designation “THS”; from Lintec Corp., Tokyo, Japan, under the trade designation “OPTERIA HARDCOATED FILMS FOR FPD”; from Sony Chemical & Device Corp., Tokyo, Japan, under the trade designation “SONY OPTICAL FILM”; from SKC Haas, Seoul, Korea, under the trade designation “HARDCOATED FILM”; and from Tekra Corp., Milwaukee, Wis., under the trade designation “TERRAPPIN G FILM”, may be used as the matrix or a component of the matrix.

In one exemplary process the hardcoat, provided in liquid form, is coated on to a first surface of the polarizer. Depending on the chemistry of the hardcoat, the liquid is cured or dried to form a dry antireflective layer on the polarizer. The hardcoated polarizer is then processed through the reactive ion etching (RIE) process described above using, in one exemplary method, the apparatus described in FIG. 1. In addition to exhibiting desirable properties including antireflective properties and antifogging properties described above, the RIE process also minimizes the undesirable phenomenon of iridescence (also referred to as “interference fringes”). The difference between the refractive index of the polarizer and the hardcoat layer can cause the phenomenon of iridescence, which occurs when external light incident on the hardcoat layer is reflected to produce rainbow-like colors. The iridescence is highly undesirable in a display application as it will obstruct the image on the display.

While some skilled in the art have tried to address the iridescence by matching the refractive index between the polarizer and coating formulations, it is very challenging to provide a balanced performance between antireflection and iridescence with quarter wavelength multilayer coatings. In some embodiments of this disclosure, the RIE process can reduce the reflection from the air-front surface interface of the polarizer coated with nanoparticle filled hardcoat, which in turn reduces the iridescence to achieve a layer exhibiting excellent antireflective properties and minimal iridescence. In other embodiments of this disclosure, nanoparticles (e.g., ZrO₂ nanoparticles) can be used to tune the refractive index of coating matrix of the hardcoat to substantially match that of the polarizer. The resulted coated layer after the RIE process disclosed herein exhibit excellent antireflective properties and minimal iridescence.

In another embodiment, the nanodispersed phase can be etched away using plasma to form a nano-structured (or nanoporous) surface. This method can be carried out using planar RIE or cylindrical RIE essentially as described above, but using etching selectivity to favor etching the nanodispersed phase rather than the matrix (i.e., by selecting gases that etch dispersed phase material rather than the matrix material).

### EXEMPLARY EMBODIMENTS

1. A composite comprising:

a polarizer having opposing first and second major surfaces; and

a nano-structured layer disposed on the first major surface of a substrate, the nano-structured layer comprising a matrix and a nano-scale dispersed phase, and having a random nano-structured anisotropic surface.

2. The composite of embodiment 1, wherein the polarizer is a reflective polarizer.
3. The composite of embodiment 1, wherein the polarizer is an absorptive polarizer.
4. The composite of any preceding embodiment, wherein the random nano-structured anisotropic surface has a percent reflection of less than 0.5% (in some embodiments, less than 0.25%).
5. The composite of any preceding embodiment, wherein the nano-structured layer comprises in a range from 0.5 to 41 (in some embodiments. 1 to 20, or even 2 to 10) percent by volume of the nano-scale dispersed phase, based on the total volume of the nano-structured layer.
6. The composite of any preceding embodiment, wherein the nano-scale dispersed phase comprises at least one of SiO₂ nanoparticles, ZrO₂ nanoparticles, TiO₂ nanoparticles, ZnO nanoparticles, Al₂O₃ nanoparticles, calcium carbonate nanoparticles, magnesium silicate nanoparticles, indium tin oxide nanoparticles, antimony tin oxide nanoparticles, poly(tetrafluoroethylene) nanoparticles, or carbon nanoparticles.
7. The composite of embodiment 6, wherein the nanoparticles are surface modified.
8. The composite of any preceding embodiment, wherein the matrix comprises cross-linked material (e.g., material made by cross-linking at least one of the following cross-linkable materials multi(meth)acrylate, polyester, epoxy, fluoropolymer, urethane, or siloxane).
9. The composite of any preceding embodiment, wherein the matrix comprises thermoplastic material (e.g., material comprising at least one of the following polymers: polycarbonate, poly(meth)acrylate, polyester, nylon, siloxane, fluoropolymer, urethane, cyclic olefin copolymer, triacetate cellulose, or diacrylate cellulose).
10. The composite of any preceding embodiment, comprising a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane.
11. The composite of any preceding embodiment, wherein the nano-structured layer comprises a microstructured surface having the random nano-structured anisotropic surface thereon.
12. The composite of any preceding embodiment, wherein the matrix comprises an alloy or a solid solution.
13. The composite of any preceding embodiment, wherein the second major surface of the polarizer includes a microstructured surface.
14. The composite of any preceding embodiment, wherein the polarizer is diffuse.
15. The composite of any preceding embodiment, further comprising an optically clear adhesive disposed on the second surface of the polarizer, the optically clear adhesive having at least 90% transmission in visible light and less than 5% haze.
16. The composite of embodiment 15 further comprising a major surface of a glass substrate, a polarizer substrate, or a touch sensor.
17. The composite of embodiment 16, further comprising a release liner disposed on the second major surface of the optically clear adhesive.
18. The composite of any preceding embodiment, further comprising a pre-mask film disposed on the random nano-structured anisotropic major surface.
19. A method of making a composite of any of embodiments 1 to 18, the method comprising:

providing a polarizer having opposing first and second major surfaces;

coating a coatable composition comprising a matrix material and a nano-scale dispersed phase in the matrix material on the first major surface of the polarizer and optionally drying the coating to provide an layer comprising a matrix and a nano-scale dispersed phase in the matrix;

exposing a major surface of the layer to reactive ion etching, wherein the ion etching comprises:
placing the layer on a cylindrical electrode in a vacuum vessel;
introducing etchant gas to the vacuum vessel at a predetermined pressure;
generating plasma between the cylindrical electrode and a counter-electrode;
rotating the cylindrical electrode to translate the polarizer; and
anisotropically etching the coating to provide the random nano-structured anisotropic major surface.
   20. The method of embodiment 19, wherein the plasma comprises an oxygen plasma.
   21. The method of either embodiments 19 or 20, wherein for the reactive ion etching, etchant is introduced at a pressure in a range from 1 milliTorr to 20 milliTorr.
   22. The method of any of embodiments 19 to 21, wherein the coating is dried to provide an layer comprising a matrix and a nano-scale dispersed phase in the matrix, and further comprising curing the dried coating.
   23. The method of any of embodiments 19 to 22, further comprising applying an optically clear adhesive disposed on the second surface of the polarizer, the optically clear adhesive having at least 90% transmission in visible light and less than 5% haze.
   24. The method of embodiment 23, further comprising applying a release liner disposed on the second major surface of the optically clear adhesive.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Procedure 1

### Plasma Treatment of Roll-to-Roll Samples

In the examples below, references to Procedure 1 describe the following operations. Polymeric film to be treated placed in the cylindrical RIE apparatus depicted in FIG. 1. More specifically, the width of the drum electrode was 14.5 inches (36.8 cm) and the pumping was carried out by means of a turbo-molecular pump. Persons with skill in the art will perceive that this means that the apparatus was operating at a much lower operating pressure than is conventionally done with plasma processing.

Rolls of the polymeric film were mounted within the chamber, the film wrapped around the drum electrode and secured to the take up roll on the opposite side of the drum. The unwind and take-up tensions were maintained at 3 pounds (13.3 N). The chamber door was closed and the chamber pumped down to a base pressure of 5×10⁻⁴ Torr. Oxygen was then introduced into the chamber. The operating pressure was nominally 10 mTorr. Plasma was generated by applying a power of 2000 watts of radio frequency energy to the drum. The drum was rotated so that the film was transported at a desired speed as stated in the specific example.

### Procedure 2

### Plasma Treatment of Sheet Samples

In the examples below, references to Procedure 2 describe a procedure similar to Procedure 1 except that sheet samples of polymeric film were taped around the edges of the drum electrode. The drum was rotated at a constant speed and plasma treatment was then done with different lengths of time as stated in the specific example.

### Procedure 3

### Measurement of Average % Reflection

In the examples below, references to Procedure 3 describe the following operations. The result of the procedure is a measure of the average % reflection (% R) of a plasma treated surface of a film. One sample of the film was prepared by applying a black vinyl tape (obtained from Yamato International Corporation, Woodhaven, Mich., under the trade designation “200-38”) to the backside of the sample. The black tape was applied using a roller to ensure there were no air bubbles trapped between the black tape and the sample. The same black vinyl tape was similarly applied to a clear glass slide of which reflection from both sides were predetermined in order to have a control sample to establish the % reflection from the black vinyl tape in isolation. When this procedure was used to measure a composite layer comprising optically clear adhesives, the composite layer was first pre-laminated to a clear glass slide, and then further laminated with the black tape to the glass surface.

The non-taped side of first the taped sample and then the control was then placed against the aperture of BYK Gardiner color guide sphere (obtained from BYK-Gardiner of Columbia, Md., under the trade designation “SPECTRO-GUIDE”) to measure the front surface total % reflection (specular and diffuse). The % reflection was then measured at a 10° incident angle for the wavelength range of 400-700 nm, and average % reflection was calculated by subtracting out the % reflection of the control.

### Procedure 4

### Refractive Index (RI) Measurement

In the examples below, references to Procedure 4 describe the following operations. The refractive indices of a sample were measured using a prism coupler (obtained from Metricon Corporation, Pennington, N.J., under the trade designation “2010/M”) using a wavelength of 632.8 nm. Three refractive indices were taken for each sample, in the machine direction as the film was made (MD), the cross-web or transverse direction as the web was made (TD), and in the direction normal to the film surface (TM). The refractive indices of MD, TD and TM are labeled as nₓ, n_{y}, and n_{z} respectively in the Examples below.

### Procedure 5

### Measurement of Average % Transmission

In the examples below, references to Procedure 5 describe the following operations. The average % transmission of a given sample was measured by placing the sample between a light source and a sample, with a measurement with no sample in place being used as a control for 100% transmission, and using a D/0 geometry. The light source was a quartz tungsten halogen (QTH) lamp powered with a stabilized power source, and a custom 4 inch (10.2 cm) sphere (obtained from Labsphere of North Sutton, N.H., under the trade designation “SPECTRALON”). Two detectors were used: a silicon CCD detector was used for the visible and near infrared (NIR), and an InGaAs diode array was used for the remainder of the NIR. A simple spectrograph with a Czerny-Turner optical layout and a single grating was used for light dispersal onto each detector. This allowed optical transmission measurement of film samples with incident measurement angles varying between 0 degrees and 60 degrees over a wavelength range of 380 nm to 1700 nm with a polarizer. The transmission was measured at normal incident angle and average % transmission was calculated and reported for the wavelength range of 400-800 nm in the following examples.

### Example 1

An acrylic hard coat comprising 10-20 wt % functionalized silica nano-particles (obtained from Momentive Performance Materials of Albany, N.Y., under the trade designation “UVHC1101”) was diluted with isopropyl alcohol (IPA) to form a 35 wt % solid solution. This solution was then syringe-pumped through a coating die onto 1.6 mil (40 micrometer) thick triacetate cellulose (TAC) film (obtained from Fujifilm Corporation, Tokyo, Japan, under the trade designation “FUJITAC SH-40”). The coating was dried at 80° C. and cured by using a UV processor equipped with an H-Bulb under a nitrogen atmosphere while being conveyed at a line speed of 50 fpm (15.25 m/min.) to form a dried coating layer approximately 2 microns thick. A 1.0 mil (25 micrometer) layer of optically clear acrylic adhesive delivered on a 2.0 mil (50 micrometer) polyester release liner (obtained from 3M Company of St. Paul, Minn. under the trade designation “3M OPTICALLY CLEAR ADHESIVE 8171”), was laminated to the second surface of the TAC film (i.e., on the opposite side of the hardcoat, to yield a composite layer). The coated side of the composite layer was subjected to roll-to-roll O₂ plasma etch (RIE) as described in Procedure 1 for 78 seconds.

Optical measurements were then obtained by removing the release liner from the optically clear adhesive and performing the test of Procedure 3. A low average reflection, approximately 0.02% reflectance, was measured. The refractive indices of the of the Example film were then measured according to Procedure 4. The nₓ was 1.514, the n_{y}, was 1.514, and the n_{z} was 1.513. (The values for the base TAC without the treatment of this Example were 1.483, 1.483, and 1.482 respectively.) The difference in refractive indices in the three directions is less than 0.01 for both the TAC film and the example coating, demonstrating that the TAC film and the coating created by the example are essentially isotropic.

### Example 2

The release liner was removed from the optically clear adhesive of the product of Example 1, and the optically clear adhesive was then laminated to a polarizing film (obtained from 3M Company under the trade designation “VIKUITI ADVANCED POLARING FILM”) to make a composite layer.

### Example 3

The release liner was removed from the optically clear adhesive of the product of Example 1, and the optically clear adhesive was then laminated to a polarizing film (obtained from 3M Company under the trade designation “VIKUITI DIFFUSE REFLECTIVE POLARIZER FILM”) to make a composite layer.

### Example 4

Four hundred grams of colloidal 20 nm silica particles (obtained from Nalco Chemical Co., Naperville, Ill., under the trade designation “NALCO 2326”) was charged to a 1 quart (0.95 liter) jar. Four hundred fifty grams of 1-methoxy-2-propanol, 27.82 grams of 3-(Methacryloyloxy)propyltrimethoxy silane, and 0.23 gram of hindered amine nitroxide inhibitor (obtained from Ciba Specialty Chemical, Inc., Tarrytown, N.Y. under the trade designation “PROSTAB 5128”) in water at 5 wt % inhibitor were mixed together and added to the jar while stirring. The jar was sealed and heated to 80° C. for 16 hours to form a surface-modified silica dispersion. 1166 grams of the surface modified silica dispersion was further mixed and combined with 70 grams of pentaerythritol triacrylate (obtained from Sartomer, Exton, Pa. under the trade designation “SR444”) and 0.58 gram of hindered amine nitroxide inhibitor (“PROSTAB 5128”) in water at 5 wt % inhibitor. The water and 1-methoxy-2-propanol were removed from the mixture via rotary evaporation to form a solution of 37.6 percent by weight 20 nm SiO₂, 56.43 wt % pentaerythritol triacrylate, and 5.97 percent by weight 1-methoxy-2-propanol. Coating solutions were then prepared by diluting the silica nano-particle solution with pentaerythritol triacrylate (“SR444”) to yield 9.6 percent by weight 20 nm SiO₂ (4.6 volume percent). The diluted concentrate coating was then further diluted with isopropanol (IPA) to 50 wt % solid coating solution. Then 1 wt % photo-initiator (obtained from BASF, Florham Park, N.J., under the trade designation “LUCIRIN TPO-L”), (ratio to the pentaerythritol triacrylate (“SR444”)) was added into the solutions and mixed well by hand shaking for at least 5 minutes. The coating solution was applied onto a polarizing film (obtained from 3M Company under the trade designation “VIKUITI ADVANCED POLARING FILM”) using a Meyer rod (#8 bar) coating device. The coated polarizing film was dried at room temperature inside a ventilated hood for 15 minutes, and then cured using an ultraviolet processor equipped with a H-Bulb under a nitrogen atmosphere while being conveyed at 50 fpm (15.2 m/min). The reflectance of the coated polarizing film was measured by Procedure 3 and found to be 48.8. The coated polarizing film was then etched according to Procedure 2 for 60 seconds. The reflectance of the etched, coated polarizing film was again measured by procedure 3 and now found to be 46.8. The etching reduced the reflection by about 2%, which is commercially significant: the change implies an enhancement of the first pass light transmission by 2% significantly improving the efficiency for backlit display applications.

### Example 5

Example 5 was performed generally as described in Example 4, except that the coating solution was instead applied to a different polarizing film, (specifically one obtained from 3M Company under the trade designation “VIKUITI. DIFFUSE REFLECTIVE POLARIZER FILM”). The reflectance of the coated, unetched polarizing film was measured by Procedure 3 and found to be 46.7. After etching, the reflectance was again measured and found to be 44.8, with similar implications for improved efficiency.

### Example 6

A silica-filled acrylic coating solution was prepared from 40 wt % of methacryloxypropyltrimethoxy silane (obtained from Crompton Corp., Middlebury, Conn., under the trade designation “A-174”) treated 20 nm silica particles (obtained from Nalco Chemical Co. under the trade designation “NALCO 2327”) in pentaerythritol triacylate (“SR444”) prepared according to the method described in Example 4. 50 wt % solid coating solution was then prepared in a 3 to 2 mixture of 1-methoxy-2-propanol to IPA. Photoinitiator (obtained from BASF Specialty Chemicals under the trade designation “IRGACURE 184”) was added into the solution at 1 wt % based on the solid content of the coating solution. The coating solution was then coated onto an absorbing polarizer (obtained from Sanritz Corp., Tokyo, Japan, under the trade designation of “LLC2-5518SF”). The coating was applied using a Meyer rod (#8 bar) coating device. The coated substrates were dried at room temperature inside a ventilated hood for 15 minutes, and then cured using an ultraviolet processor equipped with a H-Bulb under a nitrogen atmosphere while being conveyed at 50 fpm (15.25 m/min).

The % transmission of a cured, coated substrate was measured according to Procedure 5, with an uncoated polarizer positioned adjacent to it, first in the light-passing orientation, and then in the light-blocking orientation. In the passing orientation, the % transmission was 79.3 and in the blocking orientation, the % transmission was 2.1. The contrast ratio of a polarizer is defined by (average % T in passing state)/(average % T in blocking state), so in this case the contrast ratio was 38.

### Example 7

Example 7 was performed generally as described in Example 6, except that the cured coated substrate was etched according to Procedure 2 for 90 seconds. Once again, the % transmission of a cured, coated substrate was measured according to Procedure 5, with an uncoated polarizer positioned adjacent to it, first in the light-passing orientation, and then in the light-blocking orientation. In the passing orientation, the % transmission was 83.1 and in the blocking orientation, the % transmission was 1.6. The contrast ratio is therefore 52, demonstrating that the etching resulted in a 35% enhancement in contrast ratio.

Foreseeable modifications and alterations of this disclosure will be apparent to those skilled in the art without departing from the scope and spirit of this invention. This invention should not be restricted to the embodiments that are set forth in this application for illustrative purposes.

1. A composite comprising:
a polarizer having opposing first and second major surfaces; and
a nano-structured layer disposed on the first major surface of a substrate, the nano-structured layer comprising a matrix and a nano-scale dispersed phase, and having a random nano-structured anisotropic surface.

2. The composite of claim 1, wherein the polarizer is a reflective polarizer.

3. The composite of claim 1, wherein the random nano-structured anisotropic surface has a percent reflection of less than 0.5%.

4. The composite of claim 1, wherein the nano-structured article comprises in a range from 0.5 to 41 percent by volume of the nano-scale dispersed phase, based on the total volume of the nano-structured article.

5-7. (canceled)

8. The composite of claim 1, further comprising a pre-mask film disposed on the random nano-structured anisotropic major surface.

9. A method of making a composite of claim 1, the method comprising:
providing a polarizer having opposing first and second major surfaces;
coating a coatable composition comprising a matrix material and a nano-scale dispersed phase in the matrix material on the first major surface of the polarizer and
optionally drying the coating to provide a layer comprising a matrix and a nano-scale dispersed phase in the matrix; and
exposing a major surface of the layer to reactive ion etching, wherein the ion etching comprises:
placing the layer on a cylindrical electrode in a vacuum vessel;
introducing etchant gas to the vacuum vessel at a predetermined pressure;
generating plasma between the cylindrical electrode and a counter-electrode;
rotating the cylindrical electrode to translate the polarizer; and
anisotropically etching the coating to provide the random nano-structured anisotropic major surface.

10. The method of claim 9, wherein the plasma comprises an oxygen plasma.

11. The composite of claim 1, wherein the polarizer is an absorptive polarizer.

12. The composite of claim 1, wherein the nano-scale dispersed phase comprises at least one of SiO₂ nanoparticles, ZrO₂ nanoparticles, TiO₂ nanoparticles, ZnO nanoparticles, Al₂O₃ nanoparticles, calcium carbonate nanoparticles, magnesium silicate nanoparticles, indium tin oxide nanoparticles, antimony tin oxide nanoparticles, poly(tetrafluoroethylene) nanoparticles, or carbon nanoparticles.

13. The composite of claim 12, wherein the nanoparticles are surface modified.

14. The composite of claim 1, wherein the matrix comprises cross-linked material (e.g., material made by cross-linking at least one of the following cross-linkable materials multi(meth)acrylate, polyester, epoxy, fluoropolymer, urethane, or siloxane).

15. The composite of claim 1, wherein the matrix comprises thermoplastic material (e.g., material comprising at least one of the following polymers: polycarbonate, poly(meth)acrylate, polyester, nylon, siloxane, fluoropolymer, urethane, cyclic olefin copolymer, triacetate cellulose, or diacrylate cellulose).

16. The composite of claim 1, comprising a hardcoat comprising at least one of SiO₂ nanoparticles or ZrO₂ nanoparticles dispersed in a crosslinkable matrix comprising at least one of multi(meth)acrylate, polyester, epoxy, fluoropolymer, urethane, or siloxane.

17. The composite of claim 1, wherein the nano-structured layer comprises a microstructured surface having the random nano-structured anisotropic surface thereon.

18. The composite of claim 1, wherein the matrix comprises an alloy or a solid solution.

19. The composite of claim 1, wherein the second major surface of the polarizer includes a microstructured surface.

20. The composite of claim 1, wherein the polarizer is diffuse.

21. The method of claim 9, wherein for the reactive ion etching, etchant is introduced at a pressure in a range from 1 milliTorr to 20 milliTorr.

22. The method of claim 9, wherein the coating is dried to provide a layer comprising a matrix and a nano-scale dispersed phase in the matrix, and further comprising curing the dried coating.

23. The method of claim 9, further comprising applying an optically clear adhesive disposed on the second surface of the polarizer, the optically clear adhesive having at least 90% transmission in visible light and less than 5% haze.

24. The method of claim 23, further comprising applying a release liner disposed on the second major surface of the optically clear adhesive.
